(19) United States
(12) Patent Application Publication
(10) Pub. No.: US 2025/0153110 A1
(43) Pub. Date: May 15, 2025

(54) METHOD FOR THE PRODUCTION OF A MEMBRANE ENVELOPE

(71) Applicant: Blue Foot Membranes NV, Lommel (BE)

(72) Inventors: Peter AERTS, Lommel (BE); Maarten COLAERS, Lommel (BE); Ulrich BRÜSS, Lommel (BE); Stephan VAN HOOF, Lommel (BE)

(21) Appl. No.: 18/834,613

(22) PCT Filed: Jan. 31, 2023
(86) PCT No.: PCT/EP2023/052272

§ 371 Date: Jul. 30, 2024

(30) Foreign Application Priority Data
Jan. 31, 2022 (EP) 22154285.5

(51) Int. Cl. B01D 65/00; B01D 63/08; B01D 67/00; B01D 69/06; B01D 69/10; C02F 1/44

(52) U.S. Cl. CPC B01D 65/003; B01D 63/08; B01D 67/00135; B01D 69/06; B01D 69/1071; C02F 1/44; B01D 2313/14; B01D 2323/42; B01D 2323/50

(57) ABSTRACT

The current invention relates to a method for the production of a filtration membrane envelope comprising a 3D spacer fabric interposed between two membrane layers cast onto said 3D spacer fabric, wherein said method comprises a casting step, wherein during said casting step a polymer solution is applied to the outer surface of said 3D spacer fabric, wherein said polymer is applied by means of an injection process by means of a casting module and wherein said excess of coating material is removed by a casting head comprising a casting head, wherein prior or during the casting process the variation in thickness, roughness and/or tapering of the fabric is measured and the distance between the 3D fabric and the casting head is adjusted based on said measurement.

### FIELD OF THE INVENTION

The present invention relates to a method for the production of a filtration membrane envelope to be used in water treatment, more particularly water filtration and wastewater purification.

### BACKGROUND

Polymeric coating of textile surfaces is used for manufacturing filtration membranes. Coated membranes are formed by spreading a polymer solution (often referred to as a “casting dope”) into a thin film on top of a smooth substrate, using a doctor knife followed by precipitation in an aqueous bath and drying at elevated temperature. When dope casting is performed on smooth surfaces, the even spreading of the polymer solution is easy to achieve. Even spreading of the coating is essential for an even performance of the membrane along its entire surface.

A process of casting membranes or films is disclosed in US2009130517, US2020360866 and EP1298740.

Woven 3D textiles are used in the industry as substrates for membrane casting. They, however, lack uniformity of the surface and are generally variable in thickness and roughness. The outcome of the weaving process is often a tapered textile.

Membranes with 3D spacer fabrics are known from U.S. Pat. No. 7,862,718 and Doyen et al., 2009 (Desalination, vol 250, no 3).

When casting such an irregular surface as a 3D textile, a thick layer of coating is usually applied to compensate for the variability of thickness and roughness and for the tapering of the textile. Such an approach results in a significant increase in raw material use. Moreover, the coating deposit through the membrane is irregular as thicker regions of the textile have a smaller region embedded in the coating and smaller deposits on top while thinner regions of the textile can be completely embedded in the coating and have a thick deposit on top. Such irregularities can further create issues of the membrane during use. Uneven surface porosity, the difficulty of backwashing in some regions, and unevenly sized filtration channels are some examples of such issues.

The present invention aims to resolve at least some of the problems and disadvantages mentioned above. The aim of the invention is to provide a method for casting polymeric coatings on 3D textiles that take into consideration the variation of the textile surface and thickness so that membranes with uniform coatings are obtained.

### SUMMARY OF THE INVENTION

The present invention and embodiments thereof serve to provide a solution to one or more of the above-mentioned disadvantages. To this end, the present invention relates to a method for the production of a filtration membrane envelope according to claim 1. More specifically, the present invention provides a method of casting a polymer solution on a 3D spacer fabric wherein during said casting step a polymer solution is applied to the outer surfaces of said 3D spacer fabric, wherein said polymer is applied by means of an injection process by means of a casting module, characterized in that prior or during casting the variation in thickness, roughness and/or tapering of the textile is measured and the distance between the 3D textile and the casting head is adjusted based on said measurement.

It was found that real-time measuring of the variability in the thickness of the 3D spacer fabric and adjustment of casting head accordingly, results in membranes with uniform coatings throughout their surface. This provides membranes with a high degree of uniformity in terms of pore size, surface porosity, filtration channel size, and backwashing operations.

Preferred embodiments of the method are shown in any of the claims 2 to 13.

In a second aspect, the present invention relates to a filtration membrane envelope according to claim 14. More particular, the deviation in flatness of the entire membrane envelope described herein is less than 10%.

Preferred embodiments of the filtration membrane envelope are shown in claim 15.

In a third aspect, the present invention relates to a water filtration module according to claim 16. More particular, the water filtration module described herein comprises an array of planar membrane envelopes.

In a final aspect, the present invention relates to the use of a filtration module according to claim 17. More specifically, said filtration module is used for water filtration and/or wastewater purification.

### DESCRIPTION OF FIGURES

FIG. 1 shows a detail of a membrane envelope according to an embodiment of the current invention, comprised of a permeate channel interposed between two membrane layers.

FIG. 2 shows a detailed representation of the coating device according to an embodiment of the present invention.

FIG. 3 shows a schematic view of a casting process of a 3D spacer fabric according to an embodiment of the present invention.

FIG. 4 is a scanning electron microscope (SEM) view of the cross-section of a 3D spacer fabric used for manufacturing of a 3D membrane envelope according to an embodiment the invention.

### DETAILED DESCRIPTION OF THE INVENTION

The present invention concerns method for the production of a filtration membrane envelope. Furthermore, the present invention relates to a filtration membrane envelope produced by said method, to a filtration module comprising an array of planar membrane envelopes, and to a method of use of said filtration membrane envelope or filtration module.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specify the presence of what follows e.g. component and do not exclude or preclude the presence of additional, non-recited components, features, element, members, steps, known in the art or disclosed therein.

Furthermore, the terms first, second, third, and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7, etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures, or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention and form different embodiments, as would be understood by those in the art. For example, in the following claims, any of the claimed embodiments can be used in any combination.

“Flatness” as used herein is defined as the minimum distance between two planes within which all the points on a surface lie. A surface along which all the points lie along the single plane is called a perfectly flat surface.

“Roughness” as used herein refers to the irregularities of the texture of a surface as a result of any production process. The roughness of a fabric is given by the interweaving of warp and wefts, wherein said warp threads are variable in height and are distributed at various distances. Roughness is quantified by the deviations in the direction of the normal vector of a real surface from its ideal form. If these deviations are large, the surface is rough; if they are small, the surface is smooth.

“Anchorage section” as used herein is defined as a portion of the fabric embedded in the polymer cast onto said fabric.

“Filtration layer” as used herein is defined as the portion of the membrane layer cast onto said fabric that did not emerge into said fabric, but instead is present on top of the anchorage section. Usually, the filtration layer is defined by a specific porosity in the top layer formed by the precipitated polymer, typically with a pore size of between 10 nm and 1 micron. Consequently, said filtration layer may allow filtering of water.

In a first aspect, the invention relates a method for the production of a filtration membrane envelope comprising a 3D spacer fabric interposed between two membrane layers cast onto said 3D spacer fabric, wherein said method comprises a casting step. During said casting step a polymer solution is applied to the upper and lower side of said 3D spacer fabric, forming the upper and lower surfaces of the membrane. More specifically, said polymer is applied by means of an injection process by means of a casting module comprising a casting head. Prior or during the casting process, the variation in thickness, roughness, and/or tapering of the fabric is measured and the distance between the 3D fabric and the casting head is adjusted based on said measurement.

3D textiles used for filtration membranes fabrication lack uniformity of the surface and are generally variable in thickness and roughness. The outcome of the weaving process is often a tapered textile. It was found that real-time measuring of the variability in the thickness of the 3D spacer fabric and adjustment of casting head accordingly, results in membranes with uniform cast layers throughout their surface.

By preference, the thickness of the 3D spacer fabric is measured throughout its length before said fabric descends in the casting module. Said measurements are used to adjust the distance between the 3D spacer fabric and the casting head. By adjusting said distance, a uniform cast layer throughout the membrane, that takes into consideration the variation in thickness, roughness and/or tapering of the fabric, is achieved. The step of applying the membrane layers preferably comprises a casting step with cast materials and coagulation of said cast material to form a membrane layer in which the fabric is embedded. This process is known as “immersion precipitation” wherein a polymer solution is cast on a supporting layer and then submerged in a coagulation bath containing nonsolvent. Due to the solvent and nonsolvent exchange, precipitation takes place.

In an embodiment, the membrane envelope as disclosed herein is manufactured by means of a process that employs a specific casting step. It is believed that this specific manufacturing step contributes to the advantageous characteristics of the membrane envelope, such as flux and permeability and durability, as discussed above.

In an embodiment, the casting polymer solution is continuously deposited onto both sides of a 3D spacer fabric. Those sides will eventually form the lower and upper sides of said membrane.

In an embodiment, said casting process is done on a fabric that is positioned vertically and which during the casting descents in a precipitation bath. The precipitation bath preferably contains water.

Said casting process can be a one-step process or a multiple-step process, wherein a polymer is cast onto the material, and precipitated, before or after which a second round of casting or coating occurs.

Alternatively, after the deposition of the casting polymer solution on the 3D spacer fabric, said polymer solution is immediately flattened to a homogenous wet film followed by a solvent evaporation step before immersion into the precipitation bath.

In an embodiment, the cast material used in the method of the present invention comprises hydrophilic filler materials selected from the group consisting of HPC, CMC, PVP, PVPP, PVA, PVAc, PEO, TiO2, HfO2, Al2O3, ZrO2, Zr3 (PO4)4, Y2O3, SiO2, perovskite oxide materials and SiC; an organic binder material selected from the group consisting of PVC, C-PVC, PSf, PESU, PPS, PU, PVDF, PI, PAN and their grafted variants; and a solvent selected from the group consisting of NMP, DMF, DMSO or DMAC or a mixture thereof. A solvent-free process may be considered as well. It will be clear to a skilled person that also other production methods may be known in the art and applied.

The cast membrane layer obtained by the method of the invention is subjected to densification during the coagulation process. Densification is the act of reducing porosity in a sample, thereby making it denser. Due to the casting process used, the porosity of the membrane layer will gradually increase in the direction of polymer penetration of the polymer in the 3D fabric. As a result, the cast membrane layer will comprise of two sections, being a filtration layer with relatively fine or small pore size, and an anchorage section with relatively large pore size. The filtration layer will preferably have pores with a size of between 10 nm and 1 micron, whereas the pore sizes in the anchorage section will have macrovoids.

In an embodiment, the thickness of the resulting fabric with cast membrane layers is measured again after said fabric is removed from the bath.

In a preferred embodiment, the measuring of the thickness and/or roughness of said 3D fabric occurs by means of laser, preferably confocal laser, one or more sensors, or mechanically. Laser confocal measurement of the thickness and/or roughness of a surface is a non-contact measuring method that does not damage the measured surface. This is very important, especially when measuring the membrane thickness and/or roughness after the cast is applied. The light emitted by a laser is reflected by the fabric, and most of the reflected light passes through the pinhole when the target point is on the focal plane. In the range of the confocal system's Depth of Field (DOF), the reflected light intensity detected by the photodiode forms a Depth Response Curve (DRC). The peak point of the DRC detected by the photodiode indicates the focus plane of the target point on the measured surface. With a high-resolution encoder of the confocal system, the height of the target point on the surface can be measured. Thus through the recording of the heights, the fabric's profile can be obtained and roughness is derived.

Alternatively, the thickness and/or roughness of the fabric is measured by mechanical means. While any mechanical means suited in the art and known to the skilled person are possible, such mechanical means may include using measuring rolls for detecting thickness or a stylus for detecting the roughness.

In an embodiment, said measurement occurs on distinct locations of said textile, or over the entire length of said textile. As the variability in thickness, roughness and/or tapering of the fabric is caused by the weaving of the fabric and occurs randomly, it can be interesting to sample various locations of the fabric and identify them. Surface roughness measurement methods are any means suited in the art and known to the skilled person and include linear roughness measurement (profile method type), which measures roughness on a single line of the sample surface, and areal roughness measurement (areal method type), which measures roughness over an acquired area of the surface. With linear roughness measurement (profile method type), the degree of roughness in the surface is measured along an arbitrary straight line. Long, continuous dimensions are measured, and a contact stylus is commonly used to perform the roughness measurement. With areal roughness measurements (areal method type), the degree of roughness in the surface is measured over an arbitrary rectangular range. Areal roughness measurement uses a larger sampling area of the surface, providing a more accurate depiction of the state of the surface. A laser scanner is commonly used to perform areal roughness measurements.

In a further embodiment, the measurements of the fabric are communicated to a data processor, said data processor being communicatively coupled to a memory wherein said memory stores processor instructions, which, on execution, causes said processor to decide on and control the distance of said casting head. In an embodiment, the data processor is a personal computer, a smartphone, a cloud server or any other data processor known in the art. The use of a data processor and a control system allows for a real-time adjustment of the distance between the casting head and the 3D spacer fabric. With each new measurement, a corresponding adjustment of said distance is applied to result in a highly controlled membrane cast layer with maximal coverage of the fabric. The advantage of such a real-time adjustment of the membrane cast layer is that it minimizes the use of raw materials and provides a membrane with an equal layer of the cast throughout the surface of said membrane. Moreover, an anchorage section, defined as a portion of the fabric embedded, is present on the entirety of the membrane. Said anchorage section ensures high resistance of the membrane to backwashing procedures.

In an embodiment, the casting head adjustment further depends on input-variables, said variables include final cast thickness, cast volume, and/or casting speed of said casting head. The resulting thickness of the membrane layer is dependent not only on the initial thickness, roughness, and/or tapering of the 3D spacer fabric but also on the volume of applied polymer and speed at which is applied. The desired thickness of the membrane layer must also be considered and accurately determined when the distance between the casting head and the fabric is adjusted.

In a specific embodiment, 350 cm³ polymer is applied per minute, more preferably 360 cm³/min, 370 cm³/min, 380 cm³/min, 390 cm³/min, 400 cm³/min, 450 cm³/min, or 500 cm³/min. Alternatively, 200 cm³ polymer is applied per minute, more preferably 250 cm³/min, 260 cm³/min, 270 cm³/min, 280 cm³/min, 290 cm³/min, 300 cm³/min, 310 cm³/min, 320 cm³/min, 330 cm³/min, or 340 cm³/min. In a further embodiment, said input-variables are communicated to said data processor and wherein said data processor will decide on and control the distance of said casting head based on said input variables. As a result of input-variables communication to the data processor, the distance between the casting head and the fabric can be increased, decreased, or maintained.

In an embodiment, the distance of said casting head is real-time adjusted in function of said measurements.

In an embodiment, the distance between the 3D fabric and the casting head is 0.3 mm. Preferably said distance between the 3D fabric and the casting head is 0.2 mm, more preferably 0.1 mm, even more preferably 0.05 mm on each side of the 3D spacer fabric.

The 3D spacer fabric is provided as continuously moving web material during the casting. The moving of the material allows for continuous measurement of its thickness and subsequently continuous casting. Preferably, the 3D spacer fabric during coating moves at a rate of between 0.5 and 5 m/min, more preferably between 1 and 5 m/min, more preferably between 1.5 and 5 m/min, even more preferably between 2 and 5 m/min, even more preferably between 2.5 and 5 m/min, even more preferably between 3 and 5 m/min, even more preferably between 3.5 and 5 m/min, even more preferably between 4 and 5 m/min, even more preferably between 4.5 and 5 m/min. Alternatively, said 3D spacer fabric moves at a rate of between 0.5 and 1.5 m/min, between 0.5 and 1 m/min, between 0.5 and 1.5 m/min, between 0.5 and 2 m/min, between 0.5 and 2.5 m/min, between 0.5 and 3 m/min, between 0.5 and 3.5 m/min, between 0.5 and 4 m/min, between 0.5 and 4.5 m/min. The cast process can occur on a fabric that moves horizontally. In a preferred embodiment, however, the fabric moves in a vertical direction during the cast process, wherein the polymer is applied sidewise.

In an embodiment, the total thickness of said coated textile is measured after the casting process. This measurement serves as a control mean and is preferably done by a non-contact measuring method that does not damage the measured surface.

In an embodiment, the present invention relates to a method of production of a filtration membrane envelope wherein said upper and lower fabric sides are at least partially embedded in said polymer cast layers, thereby forming an upper and lower anchorage section, wherein by means of said measuring step it is ensured that the minimal thickness of said anchorage section is 100 micron, more preferably 150 micron, 200 micron, 250 micron or 300 micron. In a preferred embodiment said anchorage section has a thickness of between 100 and 500 micron, preferably between 100 and 450 micron, more preferably between 100 and 400 micron, more preferably between 100 and 350 micron, more preferably between 100 and 300 micron, more preferably between 100 and 250 micron, more preferably between 100 and 200 micron, more preferably between 100 and 150 micron.

In another embodiment, the thickness of said anchorage section is between 100 and 600 micron, between 150 and 600 micron, between 200 and 600 micron, between 250 and 600 micron, between 300 and 600 micron, between 350 and 600 micron, between 400 and 600 micron, between 450 and 600 micron, between 500 and 600 micron, preferably between 550 and 600 micron.

It will be clear to a skilled person that the thickness of the anchoring section can be measured by many methods known in the art, like scanning electron microscopy. In an embodiment, said thickness is a mean value, determined by measuring the thickness of said anchorage section at a multitude of points of the envelope. The absolute thickness at such distinct points is defined by the distance between an extreme filament, loop, or thread of the fabric and a termination point of the polymer embedded in said fabric, wherein after said termination point, the fabric is free of polymer.

In an embodiment, the 3D spacer fabric has lengthwise warp threads and transverse weft threads drawn through and inserted over and under the warp threads. It is preferred that said warp threads are aligned in a plane and delineate the anchorage sections and the membrane layers. The filtration layer is preferably represented by the zone extending from the plane of the warp threads to the exterior of the filtration membrane envelope, while the zone that included the plane of the warp threads up to the permeate channel was the anchorage section. In another preferred embodiment, the weft threads crossing over the warp threads belong to the anchorage section.

It was observed that a membrane envelope having an anchorage section should have a minimal thickness in order to make the membrane envelopes sufficiently sturdy to withstand high pressures exercised during operation activity and backflushing. No peeling or delamination, in this case, is observed. Moreover, the inventors observed that the membrane envelopes of the invention do not swell or expand their length or width when operated under submerged conditions.

By preference, the filtration layers extend from each anchorage section in a direction facing the outer side of said envelope, the minimal thickness of the extending filtration layer facing the outer side of said envelope being between 50 and 300 micron, preferably between 50 and 200 micron, more preferably between 50 and 100 micron. In an embodiment, the filtration layer thickness is the same both sides of the 3D spacer fabric. In a preferred embodiment, said filtration layer thickness may vary. For instance, one side may have a thicker filtration layer than the other side of the 3D spacer fabric.

In an embodiment, each membrane layer has a minimal total thickness of 150 micron, more preferably 200, 250, 300, 350, 400, 450, 500, 550, 600, 650, 700, 750, 800, 850, 900 micron. In another or further embodiment, each membrane layer has a total thickness of between 150 and 900 micron, preferably between 150 and 800 micron, more preferably between 150 and 700, more preferably between 150 and 600 micron, more preferably between 150 and 550 micron, more preferably between 150 and 500 micron, more preferably between 150 and 450 micron, more preferably between 150 and 400 micron, more preferably between 100 and 350 micron, more preferably between 150 and 300 micron, more preferably between 150 and 250 micron. In another embodiment, said membrane layer has a total thickness of between 150 and 900 micron, between 200 and 900 micron, between 250 and 900 micron, between 300 and 900 micron, between 350 and 900 micron, between 400 and 900 micron, between 450 and 900 micron, between 500 and 900 micron, between 550 and 900 micron, between 600 and 900 micron, between 650 and 900 micron, between 700 and 900 micron, between 750 and 900 micron, between 800 and 900 micron or between 850 and 900 micron.

The above-defined thickness of the anchorage section, thickness of the filtration layer, and embedding of the monofilaments of the spacer fabric ensure the outstanding properties of the membrane envelopes. Said membrane envelopes are sturdy, highly resistant to compression and flatness, and do not expand their length or width when operated under submerged conditions. Moreover, they show less than 10% peeling or delamination of the spacer fabric and membrane layers when subjected to a pressure of 2 bar, preferably they show less than 5% peeling or delamination, preferably less than 1% peeling or delamination. The percentage of peeling or delamination is understood as the amount of coating layer surface that comes off from the 3D spacer fabric.

In an embodiment, the compression of the membrane envelopes is of less than 5% when subjected to a static pressure of 0.5 bar, preferably 1 bar, maximum 2 bar.

In an embodiment, the membrane envelopes show less than 5%, preferably less than 4%, more preferably less than 3%, more preferably less than 2%, more preferably less than 1% compression when subjected to a static pressure of 0.5 bar, preferably between 0.5 and 2 bar.

It is preferred that the ratio between the filtration layer thickness and the anchorage section thickness is between 1:10 and 3:1, preferably between 1:9 and 3:1, between 1:8 and 3:1, between 1:7 and 3:1, between 1:6 and 3:1, between 1:5 and 3:1, between 1:4 and 3:1, between 1:3 and 3:1, between 1:2 and 3:1, between 1:1 and 3:1.

In another embodiment, the ratio between the filtration layer thickness and the anchorage section thickness is between 1:10 and 3:1, between 1:10 and 2:1, between 1:10 and 1:1.

By preference, the total thickness of the filtration membrane envelope obtained by the method of the invention is between 1 and 6 mm, preferably between 1 and 5.5 mm or between 1 and 5 mm, preferably between 1 and 4.5 mm, preferably between 1 and 4 mm, preferably between 1 and 3.5 mm, preferably between 1 and 3 mm, preferably between 1 and 2.5 mm, preferably between 1 and 2 mm.

In another embodiment, the total thickness of the filtration membrane envelope is between 1.5 and 6 mm, between 2 and 6 mm, between 2.5 and 6 mm, between 3 and 6 mm, between 3.5 and 6 mm, between 4 and 6 mm, between 4.5 and 6 mm, between 5 and 6 mm, between 5.5 and 6 mm.

The 3D spacer fabric present in the filtration membrane envelopes is formed by interwoven warp and weft threads. The warp threads are arranged in the same plane. During the weaving process, the lengthwise or longitudinal warp yarns are held stationary in tension on a frame or loom while the transverse weft is drawn through and inserted over and under the warp. The waving process if the weft threads create height variability and as tgive roughness to the surfaces of the 3D woven fabric. In an embodiment, the peaks and valley formed between the weft and warp threads, are covered by the casting layer.

In an embodiment, the 3D spacer fabric present in the filtration membrane envelopes forms a permeate channel. This permeate channel is the free space for liquid extraction in between the parallel two casting layers of the filtration membrane envelope.

In an embodiment, the permeate channel of said membrane envelope has a channel height of between 1 and 4 mm, more preferably between 1.5 and 3 mm, more preferably between 1.8 and 2.8 mm. When the above conditions are present, the pressure drop within the permeate channel is negligible during the operation of the module.

It was observed that the method described in the previous embodiments allows for a controlled casting process and provides optimal coverage of the 3D spacer fabric with said cast, reducing at the same time the amount of raw material used. The filtration membrane envelopes obtained by this method have 100% anchorage of the 3D fabric with the polymer coating. These advantages translate into high resistance to backwashing operations, uniformity of the pore size and of the permeability of the membrane, and optimal proportion of the casting layer and of the internal permeate channel.

The inventors surprisingly observed that the membrane envelopes wherein the deviations of the spacer fabric are taken into account during the casting process have controlled and uniform thickness of the layers of said membrane envelopes. The speed of the casting process, the volume of polymer applied, the positioning of the casting head, the composition of the dope or the level in the water bath can influence the casted membrane properties. The controlled and uniform thickness of the layers, which is directly influenced by the method of casting, imprints specific properties to said membrane envelope like specific permeability and attainable filtration flux. These specific properties of the membrane envelope allow for an ideal operating mode of the water filtration module as disclosed herein.

In a second aspect, the present invention relates to a filtration membrane envelope comprising a 3D spacer fabric interposed between two membrane layers, said 3D spacer fabric is a woven textile comprising an upper and lower fabric formed by weft and warp threads, wherein a polymer material is present on said upper and lower fabric, thereby forming anchorage sections wherein said polymer material is at least partially embedded in said fabric, wherein the deviation in flatness of the entire membrane envelope is less than 10%, preferably less than 8%, more preferably less than 7%, more preferably less than 6%, more preferably less than 5%, preferably less than 4%, more preferably less than 3%, more preferably less than 2%, more preferably less than 1%.

In an embodiment, the permeate channel of the filtration membrane envelope comprises open spaces, formed by said 3D spacer fabric, and the number of open spaces in said permeate channel is between 80 and 99%, preferably between 85 and 95% more, preferably between 90% and 99%. The open spaces in the permeate channel ensure an optimal flow distribution through the membrane envelopes.

In an embodiment, the 3D spacer fabric of the filtration membrane envelope is of a knitted, woven, or non-woven type. In a preferred embodiment, the 3D spacer fabric has a woven structure. In an embodiment, the 3D spacer fabric preferably comprises a material selected from the group consisting of polyester, nylon, polyamide, polyphenylene sulfide, polyethylene, and polypropylene.

By preference, the membrane envelop is planar. The membrane envelope can further comprise a sealant at the perimeter of the planar membrane envelope arranged to prevent direct fluid movement from or to the permeate channel without passing through a membrane layer, and an inlet/outlet port connection(s) in fluid connection with the permeate channel, provided at least one edge on the perimeter. Each membrane envelope can have an end portion covered by a U-shaped cap, wherein, said cap is a metal cap, preferably a stainless-steel cap.

The filtration membrane envelope described in the previous embodiments is obtained according to the method described in the present invention.

In a third aspect, the present invention relates to a water filtration module comprising an array of planar filtration membrane envelopes according to any of the embodiments described above.

In a fourth aspect, the invention relates to the use of a membrane envelope or a filtration module according to the description above, for the purification and/or filtering of a fluid such as water and/or wastewater. The membrane envelope or filtration module can be used for filtration and/or purification of surface water or of wastewater. However, it is obvious that the invention is not limited to this application. The membrane envelope or filtration module according to the invention can be applied in treating all sorts of liquid feed sources.

By preference, the membrane envelope or the water filtration module is used in operation with a backwash transmembrane pressure of at least 300 mbar. Due to the nature of the membrane envelopes, the membrane or module is particularly useful to be cleaned by means of backflushing, back pulsing, or backwashing. In an embodiment, said filtration module can be backwashed at a pressure of at least 20 mbar, more preferably at least 30 mbar, more preferably at least 40 mbar, more preferably at least 50 mbar, more preferably at least 60 mbar, more preferably at least 70 mbar, more preferably at least 80 mbar, more preferably at least 90 mbar, more preferably at least 100 mbar, more preferably at least 200 mbar, more preferably at least 300 mbar, more preferably at least 400 mbar, at least 500 mbar, at least 1 bar, at least 2 bar. This high-pressure back pulse is possible without losing the mechanical cleaning efficiency of the backwashing. During this operation, the membranes and more specifically the pores present are cleaned from any debris that was filtered out of the water. This may also include chemically enhanced backwash cleaning, wherein the pores are chemically cleaned by means of a volumetric flow of chemicals over the whole membrane envelope. As for any operation, this again requires an optimal and even flow.

The membrane envelope or the water filtration module as described herein can be used for microfiltration, ultrafiltration, MBRs, pervaporation, membrane distillation, supported liquid membranes, and/or pertraction.

It was determined that advantageously, the membrane envelope of the invention does not elongate in length or width when submerged. The structure of the membrane envelope, with the 3D spacer fabric and monofilaments threads embedded in the cast layers, ensures that when said membrane envelope is submerged in a liquid it maintains its shape and dimension without any expansion. This allows the membrane envelope to stay in place during water filtering operations, without the use of additional means for membrane stabilization e.g. comb-like structures etc.

The present invention will be now described in more detail, referring to examples that are not limitative.

### DESCRIPTION OF FIGURES

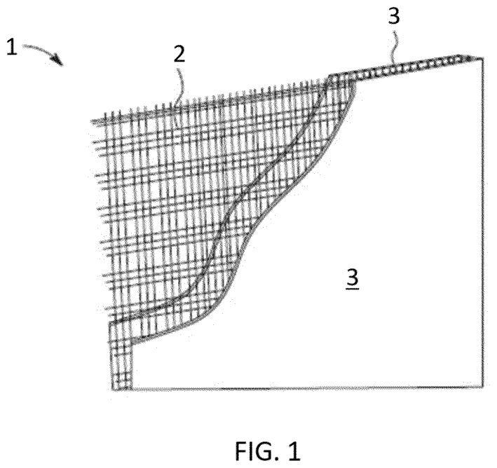

FIG. 1 shows a schematic drawing of a section of a membrane envelope 1 according to an embodiment of the invention. A 3D spacer fabric 2 is cast with polymer cast layers 3 that cover the 3D spacer fabric at both sides. The permeate channel formed by the 3D spacer fabric has between 80 and 99% of open space, that are formed by the nature of the 3D spacer fabric. Advantageously, the thickness of the spacer fabric part of the membrane envelopes is between 1.5 and 3 mm.

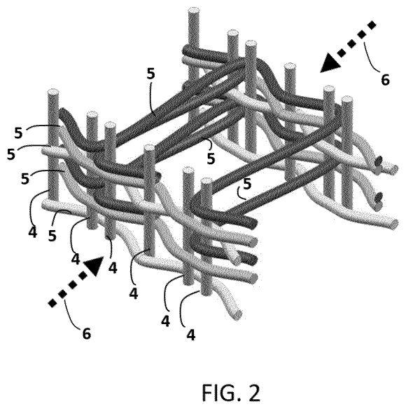

FIG. 2 shows a 3D view of the 3D spacer fabric according to an embodiment of the invention, which is formed by interwoven warp 4 and weft 5 threads. Said warp threads are variable in height and are distributed at various distances giving roughness to the surfaces of the 3D woven fabric. A polymer solution is injected on said 2D textile on both sides 6, during the casting process.

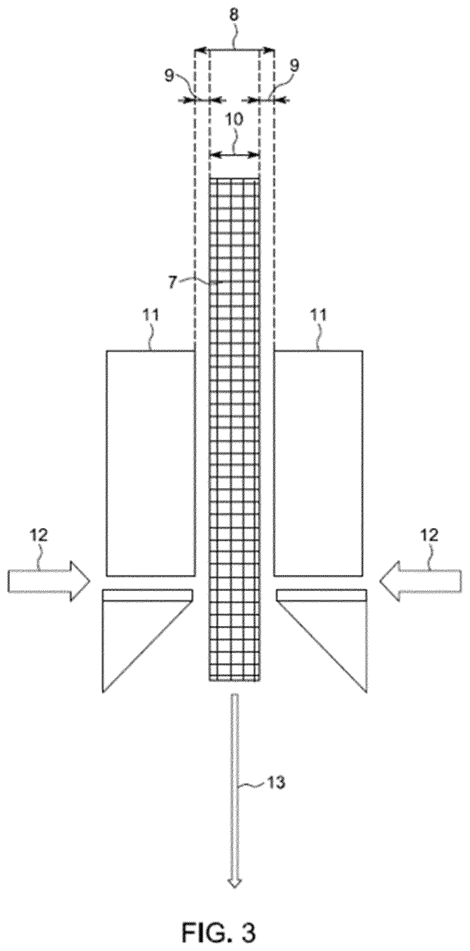

FIG. 3 shows a schematic view of a casting process of a 3D spacer fabric 7 according to an embodiment of the current invention. The thickness of said 3D spacer fabric 10 is measured in real-time. The distance between said 3D fabric and the casting head 9 is adjusted based on the desired final total membrane layer thickness 8, the volume of cast material used and/or casting speed of a casting head, and the thickness of said 3D spacer fabric. Feature 9 shows the distance between the 3D fabric and the casting head, whereas feature 10 is the thickness of the 3D spacer fabric. A polymer solution is applied using an injection process through a casting head 11 on both sides of the 3D spacer fabric. The deposition of a polymeric material 12 is done vertically while the 3D spacer fabric descends 13. The 3D spacer fabric cast with the polymer is immersed immediately thereafter, into a water precipitation bath for quick solvent/non-solvent exchange, which coagulates the polymer (not shown). The casting process can be a one-step process or a multiple step process, wherein a polymer is cast onto the material, and precipitated, after which a second round of casting occurs.

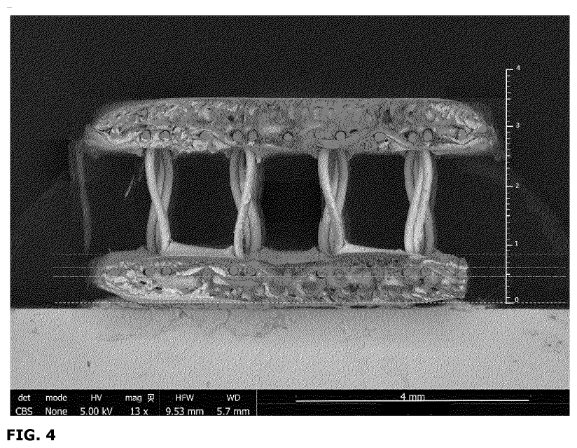

FIG. 4 is a scanning electron microscope (SEM) view of the cross-section of a 3D spacer fabric used for manufacturing of a 3D membrane envelope according to the invention.

### FIGURE NUMBERS

1 membrane envelope
2, 7 3D spacer fabric
3 polymer cast layer3D fabric and the casting head
4 warp
5 weft
6 direction of injection of the polymeric solution
8 total membrane layer thickness
9 distance between the 3D fabric and the casting head
10 thickness of the 3D spacer fabric
11 casting head
12 deposition of a polymeric material
13 direction of descending of the 3D spacer fabric during casting

### EXAMPLES

The present invention will now be further exemplified with reference to the following example. The present invention is in no way limited to the given example or to the embodiments presented in the figures.

### Example 1: Determination of the Thicknesses of the Layers of Filtration Membrane Envelopes

Scanning Electron Microscopy (SEM) was used for determining the thickness of the filtration membrane's envelope layers. Membrane samples were cut into pieces of 6×20 mm and coated in a conductive platinum (Pt) layer to avoid charging on the top and on the side of the sample.

Electron micrographs were recorded with the FEI Quanta FEG microscope using secondary (SE) and/or backscatter electrons (BSE). By using SE-electrons primarily the surface structure is displayed whereas using BSE-electrons the recording primarily shows the difference in (electron) density of the different materials. This implies that areas with a higher density and/or a larger concentration of heavier elements appear brightest and areas with lower density material are displayed darker.

The samples were arranged with the side view upwards. 4 pictures were taken from 4 different samples at a magnification of 13×.

On the SEM micrographs, the cut-through of the warp threads were visible in sections as round objects sticking out of the membrane structure and arranged in one plane by design (FIG. 4). The diameter of the warp threads was 150 μm. The plane of the warp threads delineated the anchorage section and the filtration layer. The filtration layer was the zone extending from the plane of the warp threads to the exterior of the filtration membrane envelope, while the zone that included the plane of the warp threads up to the permeate channel was the anchorage section.

The thickness of each layer was measured based on the magnification used (FIG. 4), one time for each micrograph, and the average of the 4 samples was determined.

1. A method for the production of a filtration membrane envelope comprising a 3D spacer fabric interposed between two membrane layers cast onto said 3D spacer fabric, wherein said method comprises a casting step, wherein during said casting step a polymer solution is applied to the outer surfaces of said 3D spacer fabric, wherein said polymer solution is applied by means of an injection process by means of a casting module comprising a casting head, characterized in that prior or during the casting step a variation in thickness, roughness and/or tapering of the 3D spacer fabric is measured and a distance between the 3D spacer fabric and the casting head is adjusted based on said measurement.

2. The method according to claim 1, wherein the measuring of said 3D spacer fabric occurs by means of laser, one or more sensors or mechanically.

3. The method according to claim 1, wherein a measurement occurs on distinct locations of said 3D spacer fabric, or over the entire length of said 3D spacer fabric.

4. The method according to claim 1, wherein the measurements are communicated to a data processor, said data processor being communicatively coupled to a memory wherein said memory stores processor instructions, which, on execution, causes said processor to decide on and control the distance of said casting head.

5. The method according to claim 4, wherein said casting head adjustment further depends on input-variables, said variables include final casting thickness, casting volume, and/or casting speed of said casting head.

6. The method according to claim 5, wherein said input-variables are communicated to a data processor and wherein said data processor decides on and controls the distance of said casting head based on said input variables.

7. The method according to claim 1 wherein the distance of said casting head is real-time adjusted in function of said measurements.

8. The method according to claim 1, wherein the 3D spacer fabric is provided as continuously moving web material during the casting.

9. The method according to claim 1, wherein the 3D spacer fabric during the casting moves at a rate of between 0.5 and 5 m/min.

10. The method according to claim 1, wherein after said casting a total thickness of said coated 3D spacer fabric is measured.

11. The method according to claim 1, wherein said upper and lower sides of said 3D spacer fabric are at least partially embedded in said membrane layers, thereby forming an upper and lower anchorage section, wherein by means of said measuring step it is ensured that the minimal thickness of said anchorage section is 100 micron.

12. The method according to claim 1, wherein each of said membrane layers has a minimal total thickness of 150 micron.

13. The method according to claim 1, wherein a material for the casting comprises hydrophilic filler materials selected from the group consisting of HPC, CMC, PVP, PVPP, PVA, PVAc, PEO, TiO2, HfO2, Al2O3, ZrO2, Zr3 (PO4)4, Y2O3, SiO2, perovskite oxide materials and SiC; an organic binder material selected from the group consisting of PVC, C-PVC, PSf, PESU, PPS, PU, PVDF, PI, PAN and their grafted variants; and a solvent selected from the group consisting of NMP, DMF, DMSO or DMAC or and a mixture thereof.

14. A filtration membrane envelope comprising a 3D spacer fabric interposed between two membrane layers, said 3D spacer fabric is a woven textile comprising an upper and lower fabric formed by weft and warp threads, wherein a polymer material is cast on said upper and lower fabric, thereby forming anchorage sections wherein said polymer material is at least partially embedded in said upper and lower fabric, wherein the deviation in flatness of the entire membrane envelope is less than 10%.

15. The filtration membrane envelope according to claim 14, wherein said filtration membrane envelope is obtained according to claim 1.

16. A water filtration module comprising an array of said filtration membrane envelopes according to claim 14, wherein said filtration membrane envelopes are planar.

17. Use of the filtration membrane envelope according to claim 14 for water filtration and/or wastewater purification.
